(19) United States
(12) Patent Application Publication
(10) Pub. No.: US 2026/0046703 A1
(43) Pub. Date: Feb. 12, 2026

(54) MOBILITY BETWEEN GATEWAY DEVICES IN NON-3GPP ACCESS

(71) Applicant: Nokia Solutions and Networks Oy, Espoo (FI)

(72) Inventors: Lei SU, Beijing (CN); Maximilian RIEGEL, Munich (DE); Laurent THIÉBAUT, Massy (FR)

(21) Appl. No.: 19/101,321

(22) PCT Filed: Aug. 9, 2022
(86) PCT No.: PCT/CN2022/111180

§ 371 Date: Feb. 5, 2025

(51) Int. Cl. H04W 36/00; H04W 12/08

(52) U.S. Cl. CPC H04W 36/0038; H04W 12/08

(57) ABSTRACT

Example embodiments of the present disclosure relate to devices, methods, apparatuses and computer readable storage media for status notifications of access network for time sensitive communication. In example embodiments, a terminal device determines a target access device via which the terminal device communicates with a target gateway device. Further, the terminal device transmits, to a source gateway device with which the terminal device communicates via a source access device, a message indicating a handover from the source access device to the target access device. Moreover, the terminal device communicates with the target gateway device based on the same context associated with the terminal device as the source gateway device does.

### FIELD

Example embodiments of the present disclosure generally relate to the field of communication, and in particular, to devices, methods, apparatuses and computer readable storage media for mobility between gateway devices in non-Third Generation Partnership Project (non-3GPP) access.

### BACKGROUND

3GPP Release 15 architecture supports access to the fifth generation (5G) system using 5G New Radio (NR) as well as via non-3GPP access networks. A Non-3GPP Inter-Working Function (N3IWF) has been defined as part of the untrusted non-3GPP access. Both 5G NR and non-3GPP access are interfaced to the 5G Core network (5GC) using the same user plane interfaces (N3) and control plane interfaces (N2), with the N3IWF terminating N2 and N3 interfaces.

Further, 3GPP Release 16 architecture supports the integration of wireless local area network (WLAN) systems into the 5G architecture using a trusted model. WLAN access is deployed and managed by either a 5G mobile operator or by a third party who is trusted by the 5G mobile operator. The WLAN access is trusted by both 5GC as well as by the 5G terminals once registered in the 5G system. A Trusted WLAN Access Network (TNAN) is composed of two types of network functions, that is, a Trusted WLAN Access Point (TNAP) to which user equipment (UE) is connected, and a Trusted WLAN Gateway Function (TNGF) which exposes the N2 or N3 interfaces and enables the UE to connect to the 5GC over the WLAN access technology.

### SUMMARY

In general, example embodiments of the present disclosure provide devices, methods, apparatuses and computer readable storage media for mobility between gateway devices in non-3GPP access.

In a first aspect, a method is provided. In the method, a terminal device determines a target access device via which the terminal device communicates with a target gateway device. Further, the terminal device transmits, to a source gateway device with which the terminal device communicates via a source access device, a message indicating a handover from the source access device to the target access device. Moreover, the terminal device communicates with the target gateway device based on the same context associated with the terminal device as the source gateway device does.

In a second aspect, a method is provided. In the method, a target access device receives, from a terminal device, a request to associate with the target access device, the request indicating a handover from a source access device to the target access device. Further, the target access device transmits, to the terminal device, a response for the request. Moreover, the target access device transmits, to a target gateway device with which the terminal device communicates via the target access device, an indication indicating the handover.

In a third aspect, a method is provided. In the method, a source gateway device, receives, from a terminal device, a message indicating a handover from a source access device to a target access device, the terminal device communicating with the source gateway device via the source access device, the terminal device communicating with a target gateway device via the target access device. Then, the source gateway device determines, based on the message, that a change from the source gateway device to a target gateway device is needed. Further, the source gateway device receives, from the target gateway device, a request for a context associated with the terminal device. Moreover, the source gateway device transmits the context to the target gateway device.

In a fourth aspect, a method is provided. In the method, a target gateway device receives, from a target access device via which a terminal device communicates with the target gateway device, an indication indicating a handover of the terminal device to the target access device from a source access device via which the terminal device communicates with a source gateway device. Further, the target gateway device transmits, to the source gateway device, a request for a context associated with the terminal device. Then, the target gateway device receives the context from the source gateway device. Moreover, the target gateway device communicates with the terminal device based on the context.

In a fifth aspect, a method is provided. In the method, a source gateway device receives, from a terminal device, a first message indicating a handover from a source access device to a target access device, the terminal device communicating with the source gateway device via the source access device, the terminal device communicating with a target gateway device via the target access device. Then, the source gateway device determines, based on the first message, that a change from the source gateway device to the target gateway device is needed. Further, the source gateway device transmits, to a core network device, a second message indicating the handover. Moreover, the source gateway device receives, from the core network device, a command for the handover.

In a sixth aspect, a method is provided. In the method, a target gateway device receives, from a core network device, a request for a handover of a terminal device from a source access device to a target access device, the terminal device communicating with a source gateway device via the source access device, the terminal device communicating with the target gateway device via the target access device. Then, the target gateway device receives, from the target access device, an indication indicating the handover. Then, the target gateway device transmits, to the core network device, an acknowledgement for the request. Moreover, the target gateway device communicates with the terminal device based on the same context associated with the terminal device as the source gateway device docs.

In a seventh aspect, a method is provided. In the method, a core network device receives, from a source gateway device, a message indicating a handover of a terminal device from a source access device to a target access device, the terminal device communicating with the source gateway device via the source access device, the terminal device communicating with a target gateway device via the target access device. Further, the core network device determines, based on the message, the target gateway device. Then, the core network device transmits, to the target gateway device, a request for the handover. Moreover, the core network device receives, from the target gateway device, an acknowledgement for the request.

In an eighth aspect, a terminal device is provided which comprises at least one processor and at least one memory including computer program code. The at least one memory and the computer program code are configured to, with the at least one processor, cause the terminal device to determine a target access device via which the terminal device communicates with a target gateway device. Further, the terminal device is caused to transmit, to a source gateway device with which the terminal device communicates via a source access device, a message indicating a handover from the source access device to the target access device. Moreover, the terminal device is caused to communicate with the target gateway device based on the same context associated with the terminal device as the source gateway device docs.

In a ninth aspect, a target access device is provided which comprises at least one processor and at least one memory including computer program code. The at least one memory and the computer program code are configured to, with the at least one processor, cause the target access device to receive, from a terminal device, a request to associate with the target access device, the request indicating a handover from a source access device to the target access device. Further, the target access device is caused to transmit, to the terminal device, a response for the request. Moreover, the target access device is caused to transmit, to a target gateway device with which the terminal device communicates via the target access device, an indication indicating the handover.

In a tenth aspect, a source gateway device is provided which comprises at least one processor and at least one memory including computer program code. The at least one memory and the computer program code are configured to, with the at least one processor, cause the source gateway device to receive, from a terminal device, a message indicating a handover from a source access device to a target access device, the terminal device communicating with the source gateway device via the source access device, the terminal device communicating with a target gateway device via the target access device. Then, the source gateway device is caused to determine, based on the message, that a change from the source gateway device to a target gateway device is needed. Further, the source gateway device is caused to receive, from the target gateway device, a request for a context associated with the terminal device. Moreover, the source gateway device is caused to transmit the context to the target gateway device.

In an eleventh aspect, a target gateway device is provided which comprises at least one processor and at least one memory including computer program code. The at least one memory and the computer program code are configured to, with the at least one processor, cause the target gateway device to receive, from a target access device via which a terminal device communicates with the target gateway device, an indication indicating a handover of the terminal device to the target access device from a source access device via which the terminal device communicates with a source gateway device. Further, the target gateway device is caused to transmit, to the source gateway device, a request for a context associated with the terminal device. Then, the target gateway device is caused to receive the context from the source gateway device. Moreover, the target gateway device is caused to communicate with the terminal device based on the context.

In a twelfth aspect, a source gateway device is provided which comprises at least one processor and at least one memory including computer program code. The at least one memory and the computer program code are configured to, with the at least one processor, cause the source gateway device to receive, from a terminal device, a first message indicating a handover from a source access device to a target access device, the terminal device communicating with the source gateway device via the source access device, the terminal device communicating with a target gateway device via the target access device. Then, the source gateway device is caused to determine, based on the first message, that a change from the source gateway device to the target gateway device is needed. Further, the source gateway device is caused to transmit, to a core network device, a second message indicating the handover. Moreover, the source gateway device is caused to receive, from the core network device, a command for the handover.

In a thirteenth aspect, a target gateway device is provided which comprises at least one processor and at least one memory including computer program code. The at least one memory and the computer program code are configured to, with the at least one processor, cause the target gateway device to receive, from a core network device, a request for a handover of a terminal device from a source access device to a target access device, the terminal device communicating with a source gateway device via the source access device, the terminal device communicating with the target gateway device via the target access device. Then, the target gateway device is caused to receive, from the target access device, an indication indicating the handover. Then, the target gateway device is caused to transmit, to the core network device, an acknowledgement for the request. Moreover, the target gateway device is caused to communicate with the terminal device based on the same context associated with the terminal device as the source gateway device does.

In a fourteen aspect, a core network device is provided which comprises at least one processor and at least one memory including computer program code. The at least one memory and the computer program code are configured to, with the at least one processor, cause the core network device to receive, from a source gateway device, a message indicating a handover of a terminal device from a source access device to a target access device, the terminal device communicating with the source gateway device via the source access device, the terminal device communicating with a target gateway device via the target access device. Further, the core network device is caused to determine, based on the message, the target gateway device. Then, the core network device is caused to transmit, to the target gateway device, a request for the handover. Moreover, the core network device is caused to receive, from the target gateway device, an acknowledgement for the request.

In a fifteenth aspect, there is provided an apparatus comprising means for performing the method according to one of the first to the seventh aspects.

In a sixteenth aspect, there is provided a computer readable storage medium comprising program instructions stored thereon. The instructions, when executed by a processor of a device, cause the device to perform the method according to one of the first to the seventh aspects.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A shows a 3GPP Protocol Stack for an untrusted non-3GPP access network;

FIG. 1B shows a 3GPP protocol stack for a trusted non-3GPP access network;

FIG. 2 shows an example environment in which embodiments of the present disclosure may be implemented;

FIG. 3 shows a signaling flow between devices in Xn based handover scenario according to some example embodiments of the present disclosure;

FIG. 4 shows a signaling flow between devices in N2 based handover scenario according to some example embodiments of the present disclosure;

FIG. 5 shows an example process of UE registration to 5GC in Xn based handover scenario according to some example embodiments of the present disclosure;

FIG. 6 shows an example process of UE registration to 5GC in N2 based handover scenario according to some example embodiments of the present disclosure;

FIG. 7 shows a flowchart of an example method for a terminal device according to some example embodiments of the present disclosure;

FIG. 8 shows a flowchart of an example method for a target access device according to some example embodiments of the present disclosure;

FIG. 9 shows a flowchart of an example method for a source gateway device according to some example embodiments of the present disclosure;

FIG. 10 shows a flowchart of an example method for a target gateway device according to some example embodiments of the present disclosure;

FIG. 11 shows a flowchart of an example method for a source gateway device according to some other example embodiments of the present disclosure;

FIG. 12 shows a flowchart of an example method for a target gateway device according to some other example embodiments of the present disclosure;

FIG. 13 shows a flowchart of an example method for a core network device according to some example embodiments of the present disclosure; and

FIG. 14 shows a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “access device” refers to a device via which services may be provided to a terminal device in a cellular communication network. Examples of the access device include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like. For the purpose of discussion, some example embodiments will be described by taking a base station as an example of the access device.

As used herein, the term “terminal device” refers to any device capable of wireless communications with each other or with the access device. The communications may involve transmitting and/or receiving wireless signals using electromagnetic signals, radio waves, infrared signals, and/or other types of signals suitable for conveying information over air. Example of the terminal device may comprise user equipment (UE). In some example embodiments, the UE may be configured to transmit and/or receive information without direct human interaction. For example, the UE may transmit information to the base station on predetermined schedules, when triggered by an internal or external event, or in response to requests from the network side.

As used herein, in some example embodiments, the term “core network device” refers to a device capable of communicating with the access device and providing services to the terminal device in a core network. Examples of the core network device may include user plane functions (UPFs), application servers, Mobile Switching Centers (MSCs), MMEs, Operation and Management (O&M) nodes, Operation Support System (OSS) nodes, Self-Organization Network (SON) nodes, positioning nodes such as Enhanced Serving Mobile Location Centers (E-SMLCs), Mobile Data Terminals (MDTs), a Common Control Network Function (CCNF), an Access and mobility Management Function (AMF), a Session Management Function (SMF), a Policy Control Function (PCF).

As used herein, in some example embodiments, the term “gateway device” refers to a device used to communicate with an access device, such as an AP, and a core network device, such as an AMF, for non-3GPP access. For example, the gateway device may comprise a TNGF and/or a N3IWF.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

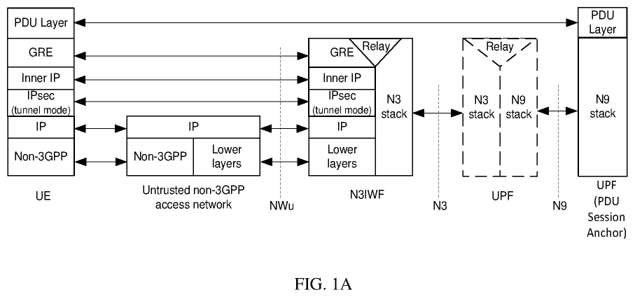

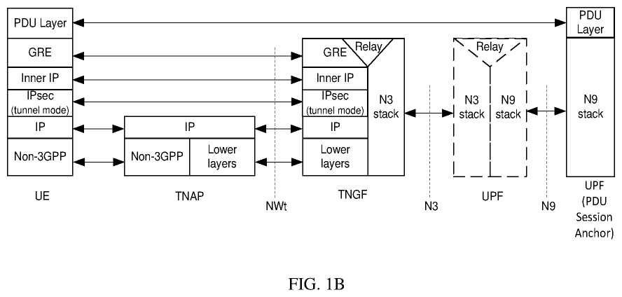

As described above, 3GPP Release 15 architecture supports access to the fifth generation (5G) system using 5G New Radio (NR) as well as via non-3GPP access networks. A Non-3GPP Inter-Working Function (N3IWF) has been defined as part of the untrusted non-3GPP access. Both 5G NR and non-3GPP access are interfaced to the 5G Core network (5GC) using the same user plane interfaces (N3) and control plane interfaces (N2), with the N3IWF terminating N2 and N3 interfaces. A 3GPP Protocol Stack for an untrusted non-3GPP access network is shown in FIG. 1A.

Further, 3GPP Release 16 architecture supports the integration of wireless local area network (WLAN) systems into the 5G architecture using a trusted model. In this case, WLAN access is deployed and managed by either a 5G mobile operator or by a third party who is trusted by the 5G mobile operator. The WLAN access is trusted by both 5GC as well as by the 5G terminals once registered in the 5G system. A Trusted WLAN Access Network (TNAN) is composed of two types of network functions, that is, a Trusted WLAN Access Point (TNAP) to which user equipment (UE) is connected, and a Trusted WLAN Gateway Function (TNGF) which exposes the N2 or N3 interfaces and enables the UE to connect to the 5GC over the WLAN access technology. A 3GPP protocol stack for a trusted non-3GPP access network is shown in FIG. 1B. The TNGF is from wireless fidelity (WiFi)/WLAN perspective part of a core network but from 3GPP perspective it is part of an access network.

When deploying Internet Protocol security (IPsec) for the connectivity between UE and 5GC, there is no need for link layer security on the WLAN link. Therefore, the non-trusted non-3GPP access does not mandate the wireless fidelity (Wi-Fi) protected access (WPA) 2/3-Enterprise mode of access authentication, and makes use of the 5G Extensible Authentication Protocol (EAP) authentication method only for establishing the security association for the IPsec tunnel based on Internet Key Exchange (IKE)-v2.

However, most of the public WLAN access networks meanwhile provide a secured access mode based on WPA 2/3-Enterprise with automatic attachments of UEs through their subscriber identity module (SIM)/Authentication and Key Agreement (AKA) credentials. Worldwide roaming across such secured public WLAN access is currently getting widely deployed through the OpenRoaming project of the Wireless Broadband Alliance (WBA), which reduces the operational overhead of becoming a partner in the global roaming consortia. The WLAN technology deployed in OpenRoaming networks is the same that is used by mobile operators in their own trusted WLAN access networks. With such convergence of the access technology, it becomes feasible that a mobile operator establishes global WLAN roaming capabilities for their subscribers by leveraging OpenRoaming techniques and demand of seamless mobility across all the WLAN access because of the compatible security levels. A mobile operator can even signal a single, worldwide mobility domain through virtual WLAN access networks indicating the same service set identity (SSID) and mobility domain across multiple WLAN access providers.

Even when such deployment scenario formally does not cohere to the trusted WLAN access, it could deploy the access procedures defined for trusted WLAN access and provide an extended coverage access infrastructure consisting of several access networks belonging to different access providers each being connected through a dedicated N3IWF to the 5GC. In this case the N3IWF would exactly behave like the TNGF and could establish a wide area WLAN access across multiple WLAN access domains under the control of a 5G mobile network operator.

Thus, developments in WLAN roaming make it feasible to support fully automatic network access over wider area. It is desirable to enable seamless connectivity to 5G services without disruptions when changing WLAN access. Deployment of the same SSID/extended service set (ESS) across multiple WLAN access indicates to UEs seamless connectivity to IP services, but operational set-up of the WLAN access could require to deploy multiple instances of the TNGF or N3IWF to serve different adjacent WLAN access zones.

The current 3GPP architecture for integration of Wi-Fi with the 5GC allows only spotty coverage without mobility support between adjacent Wi-Fi access areas, when the WLAN access would be connected through different TNGFs or N3IWFs with the 5GC. Each of the Wi-Fi access networks defined through a TNGF or N3IWF currently establishes an independent access area and requires full re-authentication, re-authorization, and reestablishment of the IPsec tunnel when UEs move between them. Currently, there is no mobility support available for transition between different TNGFs or N3IWFs.

The need of reestablishment of the IPsec tunnel when changing the TNGF or N3IWF breaks seamless connectivity for 5G services, even when WLAN transition within the same SSID/ESS would indicate to the UE uninterrupted access to IP services. Due to reestablishment of the IPsec, IP connectivity is teared down at the UE, and a complete reattachment is necessary to bring back IP connectivity to 5G services. Therefore, it is desirable to enable to maintain the security association and the IPsec tunnel when changing the tunnel endpoint from one TNGF or N3IWF to another TNGF or N3IWF.

In an aspect, some example embodiments of the present disclosure provide a scheme of mobility between gateway devices in non-3GPP access in Xn based handover scenario. As an example, the target access device may be a target AP, and the source gateway device or the target gateway device may be a TNGF or a N3IWF.

In this scheme, a terminal device determines a target access device via which the terminal device communicates with a target gateway device. Then, the terminal device transmits, to a source gateway device with which the terminal device communicates via a source access device, a message indicating a handover from the source access device to the target access device. Further, the terminal device transmits, to a target access device, a request indicating the handover to associate with the target access device. Then, the target access device transmits, to the terminal device, a response for the request and transmits, to the target gateway device, an indication indicating the handover. The target gateway device transmits, to the source gateway device, a request for a context associated with the terminal device. Then, the source gateway device transmits the context to the target gateway device. The terminal device communicates with the target gateway device based on the same context associated with the terminal device as the source gateway device docs.

In another aspect, some example embodiments of the present disclosure provide a scheme of mobility between gateway devices in non-3GPP access in N2 based handover scenario. As an example, the target access device may be a target AP, and the source gateway device or the target gateway device may be a TNGF or a N3IWF, and the core network device may be an AMF.

In this scheme, a terminal device determines a target access device via which the terminal device communicates with a target gateway device. Then, the terminal device transmits, to a source gateway device with which the terminal device communicates via a source access device, a first message indicating a handover from the source access device to the target access device. Then, the source gateway device transmits, to a core network device, a second message indicating the handover. The core network device determining, based on the second message, the target gateway device and then transmits, to the target gateway device, a request for the handover. Further, the terminal device transmits, to a target access device, a request indicating the handover to associate with the target access device. Then, the target access device transmits, to the terminal device, a response for the request and transmits, to the target gateway device, an indication indicating the handover. The target gateway device transmits, to the core network device, an acknowledgement for the request. Then, the target gateway device communicates with the terminal device based on the same context associated with the terminal device as the source gateway device does.

These schemes facilitate flexible and efficient handover between gateway devices in non-3GPP access in both Xn based handover scenario and N2 based handover scenario. As such, it is allowed to enable seamless connectivity to 5G services without disruptions when changing WLAN access. Thus, user experiences may be improved significantly.

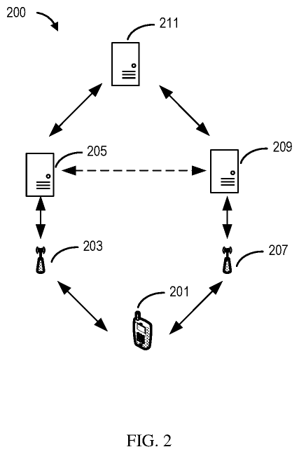

FIG. 2 shows an example environment 200 in which embodiments of the present disclosure may be implemented.

As shown, the environment 200, which is a part of a communication network, includes a terminal device 201 and an access device (referred to as a source access device) 203. The environment 200 further includes a gateway device (referred to as a source gateway device) 205. For example, the terminal device 201 may communicate with the source gateway device 205 via the source access device 203.

The environment 200 further includes another access device (referred to as a target access device) 207 and another gateway device (referred to as a target gateway device) 209. As shown, the target access device 207 acts as an intermediate between the terminal device 201 and the target gateway device 209.

The environment 200 further includes a core network device 211. The source gateway device 205 and the target gateway device 209 may be connected to the core network device 211 directly or indirectly via one or more other devices or functions. Similarly, the connection between the source access device 203 and the source gateway device 205 and the connection between the target access device 207 and the target gateway device 209 may be direct or indirect.

In some embodiments, the source gateway device 205 and the target gateway device 209 may communicate directly or indirectly via one or more other devices or functions.

In some example embodiments, the source gateway device 205 may be physically integrated into the source access device 203 and, for example, implemented as a function or entity physically integrated into the source access device 203. In this case, the source gateway device 205 may communicate with the source access device 203 through internal wiring. Likewise, in some example embodiments, the target gateway device 209 may be physically integrated into the target access device 207 and, for example, implemented as a function or entity physically integrated into the target access device 207. In this case, the target gateway device 209 may communicate with the target access device 207 through internal wiring.

The communication between the individual devices or functions in the environment 200 may follow any suitable communication standards or protocols, which are already in existence or to be developed in the future. The scope of the present disclosure will not be limited in this regard.

It is to be understood that the devices or functions are shown in the environment 200 only for the purpose of illustration, without suggesting any limitation. The environment 200 may include any other suitable devices, elements or functions for providing communication. For example, there may be one or more intermediates between the source access device 203 and the source gateway device 205 and/or between the source gateway device 205 and the core network device 211.

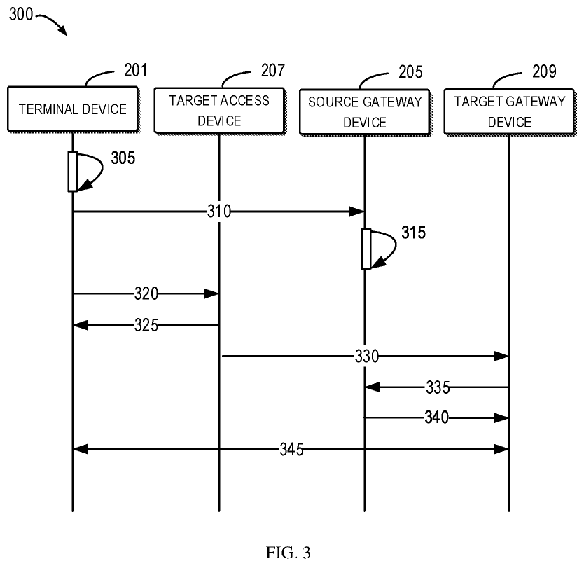

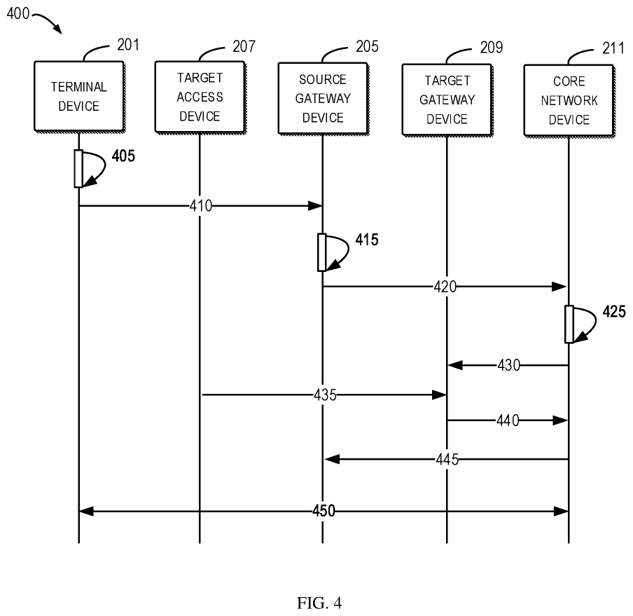

High-level interactions between the devices and functions in the environment 200 will be discussed below with reference to FIGS. 3-4.

FIG. 3 shows a signaling flow between devices in Xn based handover scenario according to some example embodiments of the present disclosure. For the purpose of discussion, the signaling flow 300 will be described with reference to FIG. 2. For example, the terminal device 201 may be implemented by a UE, the target access device 207 may be implemented by an AP, the source gateway device 205 may be implemented by a TNGF or a N3IWF, and the target gateway device 209 may be implemented by a TNGF or a N3IWF.

As shown in FIG. 3, the terminal device 201 determines (305) the target access device 207 via which the terminal device 201 communicates with the target gateway device 209. In some example embodiments, the terminal device 201 may perform WLAN measurements to provide better guidance of finding the candidate access devices providing the required connectivity. When the terminal device 201 determines based on internal policies that the current WLAN radio link does not anymore provide the required level of service, it may scan the environment and select the best target access device for a seamless handover to maintain the required quality of service. As an example, the terminal device 201 may check and verify that the target access device 207 indicates the same SSID and eventually homogeneous extended service set identification (HESSID) when provided. As an example, if the terminal device 201 determines that there is better performance at a plurality of candidate access devices including the target access device 209 than the source access device 205, it may determine, from the plurality of candidate access devices, the target access device 209.

Then, the terminal device 201 transmits (310), to the source gateway device 205, a message indicating a handover from the source access device 203 to the target access device 207. For example, the message may comprise at least one of: an identifier of the terminal device 201 and an identifier of the target access device 207. As an example, the identifier may comprise a media access control (MAC) address. Alternatively or in addition, the identifier may comprise other kinds of identifiers for identification, without suggesting any limitation as to the scope of the disclosure. Then, the source gateway device 205 determines (315), based on the message, that a change from the source gateway device 205 to a target gateway device 209 is needed. For example, the source gateway device 205 may determine the target gateway device 209 based on the identifier of the target access device 207. It is to be understood that the source gateway device 205 may determine the target gateway device 207 in other ways, without suggesting any limitation as to the scope of the disclosure.

In some example embodiments, the terminal device 201 transmits (320), to the target access device 207, a request to associate with the target access device 207. As an example, the request may indicate the handover from the source access device 203 to the target access device 207. For example, the request may comprise an identifier of the source access device 203. The target access device 207 transmits (325) to the terminal device 210 a response for the request. Then, the target access device 207 transmits (330), to the target gateway device 209, an indication indicating the handover. As an example, the indication may comprise at least one of: an identifier of the terminal device 201, the identifier of the source access device 203, and the identifier of the target access device 207.

Then, in some example embodiments, the target gateway device 209 may determine the source gateway device 205 based on the identifier of the source access device 203 comprised in the indication. In this case, each TNGF including the source gateway device 205 may register its Xn address onto a Network Repository Function (NRF) with a list of the MAC addresses of the access device it serves, for example using Nnrf_NFManagement_NFRegister operation defined in 3GPP Technical Specification (TS) 23.502. Thus, the target gateway device 209 may be configured with the list of access devices that a neighboring TNGF serves. The target gateway device 209 may then look up a common database, such as the NRF. For example, the target gateway device 209 may discover the source gateway device 205 by issuing for example a Nnrf_NFDiscovery_Request operation as defined in 3GPP TS 23.502, providing the identifier of the source access device 203 as input parameter. It is to be understood that the target gateway device 209 may determine the source gateway device 205 in other ways, without suggesting any limitation as to the scope of the disclosure.

As shown in FIG. 3, the target gateway device 209 transmits (335), to the source gateway device 205, a request for a context associated with the terminal device 201. In some example embodiments, the context may comprise security information for communication with the terminal device 201 at the target access device 207. For example, the context may comprise a key for communication with the terminal device 201. For example, the context may comprise an EAP Re-authentication Rook Key (Rrk). Alternatively or in addition, the context may comprise parameters associated with internet protocol security with the target gateway device 209. For example, the context may comprise IPSec related parameters, such as, Security Parameter Index SPI, a list of Security Associations (SA), traffic filters per SA, and/or IPSec Sequence Numbers per SA. As another example, the context may comprise the 3GPP keying material received from the 5GC.

In some example embodiments, the request for the context may comprise at least one of: the identifier of the terminal device 201, the identifier of the source access device 203, the identifier of the target access device 207, and an internet protocol address of the target gateway device 209. In response, the source gateway device 205 transmits (340) the context to the target gateway device 209. For example, the terminal device 201 may issue related EAP signalling relayed by the target access device 207 to the target gateway device 209 making use of the EAP re-authentication protocol, as it joins the target access device 207. Then, the target gateway device 209 may reuse information received in the context, for example, the EAP Rrk, to derive through the EAP re-authentication procedure a new working key, such as a new PMK, to be used for WLAN security, while the IPSec SA security parameters may be unchanged, related to a previous PMK determined at UE latest connection to the network for example at UE registration.

After that, some IEEE security procedures may be performed. For example, the procedures may comprise the succeeding EAP message exchanges, as well as the 4-way handshake to establish the various keys needed for secured WLAN communications. Then, the terminal device 110 communicates (345) with the target gateway device 209 based on the same context associated with the terminal device 201 as the source gateway device 205 does. For example, the terminal device 201 may then start using the target access device 207 to transmit uplink (UL) traffic. The target TNGF 507 may starts IPSec state machines. For example, the IPsec endpoint may then be enabled.

Further, the source gateway device 205 may receive an indication for resource release. Then, the source gateway device 205 may release resources for communication with the terminal device 201 by at least disabling an internet protocol security endpoint.

In this way, it may achieve flexible and efficient handover between gateway devices in non-3GPP access in Xn based handover scenario. As such, it is allowed to enable seamless connectivity to 5G services without disruptions when changing WLAN access. Thus, user experiences may be improved significantly.

FIG. 4 shows a signaling flow between devices in N2 based handover scenario according to some example embodiments of the present disclosure. For the purpose of discussion, the signaling flow 400 will be described with reference to FIG. 2. For example, the terminal device 201 may be implemented by a UE, the target access device 207 may be implemented by an AP, the source gateway device 205 may be implemented by a TNGF or a N3IWF, the target gateway device 209 may be implemented by a TNGF or a N3IWF, the core network device 211 may be implemented by an AMF.

As shown in FIG. 4, the terminal device 201 determines (405) the target access device 207 via which the terminal device 201 communicates with the target gateway device 209. The terminal device 201 may determines the target access device 207 in similar ways as described with reference to FIG. 3.

Then, the terminal device 201 transmits (410), to the source gateway device 205, a message (also referred to as a first message) indicating a handover from the source access device 203 to the target access device 207. For example, the first message may comprise at least one of: an identifier of the terminal device 201 and an identifier of the target access device 207. As an example, the identifier may comprise a media access control (MAC) address. Alternatively or in addition, the identifier may comprise other kinds of identifiers for identification, without suggesting any limitation as to the scope of the disclosure. Then, the source gateway device 205 determines (415), based on the first message, that a change from the source gateway device 205 to a target gateway device 209 is needed. For example, the source gateway device 205 may determine the target gateway device 209 based on the identifier of the target access device 207 comprised in the first message. Likewise, the source gateway device 205 may be configured with the list of access devices that a neighboring TNGF or a N3IWF serves. The source gateway device 205 may then look up a common database, such as a Network Repository Function (NRF). For example, source gateway device 205 may discover the target gateway device 209 by issuing for example a Nnrf_NFDiscovery_Request operation as defined in 3GPP TS 23.502, providing the identifier of the target access device 207 as input parameter. It is to be understood that the source gateway device 205 may determine the target gateway device 207 in other ways, without suggesting any limitation as to the scope of the disclosure.

As shown in FIG. 4, the source gateway device 205 transmits (420), to the core network device 211, another message (also referred to as a second message) indicating the handover. In some example embodiments, the second message may comprise at least one of: the identifier of the target access device 207, an identifier of the target gateway device 209, a context associated with internet protocol security, and a context associated with authentication protocol security, such as EAP security. For example, the second message may comprise an Rrk that is used to establish WLAN security context at the EAP re-authentication to avoid the need to perform a complete EAP authentication procedure with the 5GC.

Then, the core network device 211 determines (425), based on the second message, the target gateway device 209. As an example, the core network device 211 may determine the target gateway device 209 based on the identifier of the target access device 207 comprised in the second message. Further, based on the second message, the core network device 211 may further perform a preparation for the handover. For example, the core network device 211 may interact with a SMF and a UPF for the handover. As an example, the transparent 5G access network (AN) to 5G AN container may contain TNGF related information.

Then, the core network device 211 transmits (430), to the target gateway device 209, a request for the handover. For example, the request may comprise at least one of: an identifier of the target gateway device 209, the context associated with internet protocol security, and the context associated with authentication protocol security. As an example, the request may contain TNGF related information comprised in the second message. Thus, the context associated with the terminal device 201 may be obtained by the target gateway device 209 based on the request from the core network device 211 for future communication with the terminal device 201. In some example embodiments, the context associated with the terminal device 201 may comprise security information for communication with the terminal device 201 at the target access device 207. For example, the context may comprise a key for communication with the terminal device 201. For example, the context may comprise an EAP Re-authentication Rook Key (Rrk). Alternatively or in addition, the context may comprise parameters associated with internet protocol security with the target gateway device 209. For example, the context may comprise IPSec related parameters, such as, Security Parameter Index SPI, a list of Security Associations (SA), traffic filters per SA, and/or IPSec Sequence Numbers per SA. As another example, the context may comprise the 3GPP keying material received from the 5GC.

In some example embodiments, the terminal device 201 may transmit, to the target access device 207, a request to associate with the target access device 207. As an example, the request may indicate the handover from the source access device 203 to the target access device 207. For example, the request may comprise an identifier of the source access device 203. The target access device 207 may transmit to the terminal device 210 a response for the request. Then, the target access device 207 transmits (435), to the target gateway device 209, an indication indicating the handover. As an example, the indication may comprise at least one of: an identifier of the terminal device 201, the identifier of the source access device 203, and the identifier of the target access device 207. Then, in response to the request for the handover from the core network device 211, the target gateway device 209 transmits (440), to the core network device 211, an acknowledgement for the request.

In some example embodiments, the core network device 211 may transmit (445), to the source gateway device 205, a command for the handover. For example, the command may instruct the source gateway device 205 to release resources for communication with the terminal device 201 by at least disabling an internet protocol security endpoint. In response to the command, the source gateway device 205 may disable an internet protocol security endpoint.

Then, in some example embodiments, the IEEE security EAP Re-authentication procedure may be performed. Once the target gateway device 209 has received the first AAA messaging corresponding to the IEEE security EAP re-authentication procedure and the transparent 5G AN to 5G AN container with EAP security context (Rrk), the target gateway device 209 may proceeds with the remaining messages of the EAP re-authentication procedure. Further, the IEEE security procedures may be performed through the 4 ways handshake to establish a working key at the terminal device 201 and the target access device 207. When re-association together with link security establishment is done, the terminal device 201 may start sending uplink traffic that can be handled by the target gateway device 209 based on IPSec security context received over the N2 interface. Then, as shown in FIG. 4, the target gateway device 209 communicates (450) with the terminal device 201 based on the same context associated with the terminal device 201 as the source gateway device 205 docs.

In this way, it may achieve flexible and efficient handover between gateway devices in non-3GPP access in N2 based handover scenario. As such, it is allowed to enable seamless connectivity to 5G services without disruptions when changing WLAN access. Thus, user experiences may be improved significantly.

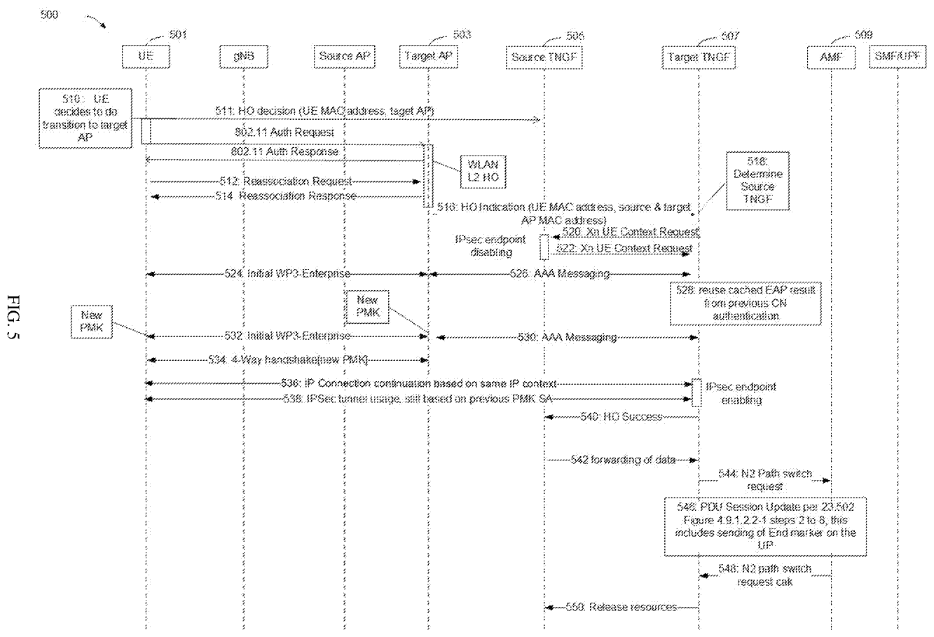

FIG. 5 shows an example process of UE registration to 5GC in Xn based handover scenario according to some example embodiments of the present disclosure. For the purpose of discussion, the process 500 will be described with reference to FIG. 2. For example, in this case, the terminal device 201 may be implemented by a UE 501, and the target access device 207 may be implemented by a target AP 503, and the source gateway device 205 may be implemented by a source TNGF 505, and the target gateway device 209 may be implemented by a target TNGF 507, and the core network device 211 may be implemented by an AMF 509.

As shown in FIG. 5, at 510, the UE 501 decides to do transition to the target AP 503. At 511, the UE 501 informs the source TNGF 505 about the target AP 503 it has selected after it has made a handover (HO) decision. In this case, a message indicating the handover comprising UE MAC address and target AP MAC address is transmitted by the UE 501 to the source TNGF 505. At 512-514. The UE 501 issues a re-association with the target AP 503 providing the source AP MAC address.

Then, at 516, the target AP 503 issues a HO indication to the target TNGF 507, providing the UE MAC address as well as the source and target AP MAC address. At 518, the target TNGF 507 determines the source TNGF 505 based on the source AP MAC address. For example, this determination may use a target TNGF discovery using the NRF where the target TNGF discovery uses the target AP and the SSID as search criteria. At 520, the target TNGF 507 issues an Xn UE context Request providing the UE MAC address as well as the source and target AP MAC address as well as an address where to receive DL traffic not delivered to the UE 501 and forwarded to the target TNGF 507, such as an internet protocol address of the target TNGF 507. In response, the source TNGF 505 stops its IPSec state machines and, at 522, provides the UE context in Xn UE context response. For example, the UE context may comprise the contents described with reference to FIG. 3. At 524-526, the UE 501, as it joins the target AP 503, issues related EAP signalling relayed by the target AP 503 to the target TNGF 507 making use of the EAP re-authentication protocol. At 528, the target TNGF 507 reuses information received at 522, for example, the EAP Rrk, to derive through the EAP re-authentication procedure new working keys, such as a new PMK, to be used for WLAN security, while the IPSec SA security parameters are unchanged, related to the previous PMK determined at UE latest connection to the network for example at UE registration.

At 530-534, the IEEE security procedures are performed, comprising the succeeding EAP message exchanges, as well as the 4-way handshake to establish the various keys needed for secured WLAN communications. At 536-538, the UE 501 starts using the target AP 503 to send uplink (UL) traffic. The target TNGF 507 starts IPSec state machines using e.g. information received at step 522. At 540, the target TNGF 507 sends an Xn HO Success to the source TNGF 505 to indicate the success of the HO and to request actual forwarding of DL data held at the source TNGF 505. At 542, DL data held at the source TNGF 505 is forwarded to the target TNGF 507. At 544, the target TNGF 507 sends a N2 Path switch request as to the AMF 509. The target TNGF 507 informs 5GC that the UE 501 has moved to the target AP 503 and provides a list of PDU sessions to be switched. Tunnel Information for each PDU Session to be switched is included in the N2 SM Information and refers to the target TNGF 507. At 546, the procedure of Session Update is performed. At 548, a N2 path switch request is transmitted to the target TNGF 507. At 550, an indication to release resources is transmitted to the source TNGF 505.

All operations and features as described above with reference to FIG. 3 are likewise applicable to the process 500 and have similar effects. For the purpose of simplification, the details will be omitted.

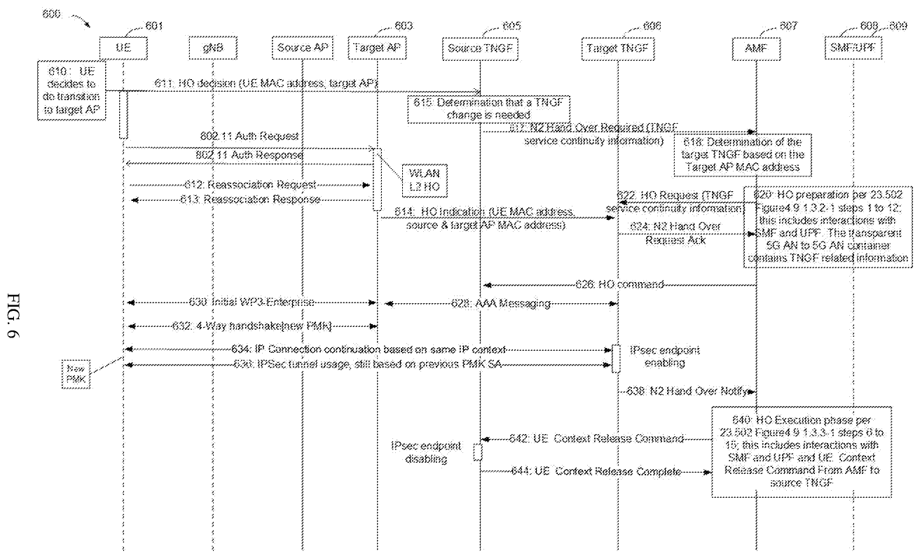

FIG. 6 shows an example process of UE registration to 5GC in Xn based handover scenario according to some example embodiments of the present disclosure. For the purpose of discussion, the process 600 will be described with reference to FIG. 2. For example, in this case, the terminal device 201 may be implemented by a UE 601, and the target access device 207 may be implemented by a target AP 603, and the source gateway device 205 may be implemented by a source TNGF 605, and the target gateway device 209 may be implemented by a target TNGF 606, and the core network device 211 may be implemented by an AMF 607.

As shown in FIG. 6, at 610, the UE 601 decides to do transition to the target AP 603. At 611, the UE 601 informs the source TNGF 605 about the target AP 603 it has selected after it has made a HO decision. In this case, a message indicating the handover decision from the UE 601 comprising UE MAC address and target AP MAC address is transmitted by the UE 601 to the source TNGF 605. At 612-613, The UE 601 issues a re-association with the target AP 603 providing the source AP MAC address. Then, at 614, the target AP 603 issues a HO indication to the target TNGF 606, providing the UE MAC address as well as the source and target AP MAC address.

Further, as triggered by the HO indication at 611, at 615, At 612, the source TNGF 605 determines that a TNGF change is needed. For example, the source TNGF 605 may determine the target TNGF 606 based on the target AP MAC address. At 617, the source TNGF 605 issues a N2 HO Required message to the AMF 607. This message may comprise TNGF service continuity information such as an identifier of the target TNGF 606 to indicate the target TNGF 606 but may also further contain IPSec context and TNGF EAP security context in particular the re-authentication root key (Rrk) that is used to establish WLAN security context at the target AP EAP re-authentication to avoid the need to perform a complete EAP authentication procedure with the 5GC via an Authentication Server Function (AUSF). At 618, the AMF 607 determines the target TNGF 606 based on the target AP MAC address. At 620, the AMF 607 performs HO preparation. For example, interactions with the SMF 608 and the UPF 609 are performed. At 622, the AMF 607 sends a HO Request to the target TNGF 606 where the transparent 5G AN to 5G AN container contains TNGF service continuity information comprised in the N2 HO Required message. At 624, the target TNGF 606 answers with a HO Request Ack.

Then, at 626, a HO command is sent to the source TNGF 605. Upon receiving the Handover Command, the source TNGF 605 disables the original IPSec endpoint. At 628-630, the IEEE security EAP Re-authentication procedure is performed. Once the target TNGF 606 has received the first AAA messaging corresponding to the IEEE security EAP re-authentication procedure and the transparent 5G AN to 5G AN container with TNGF EAP security context (Rrk), the target TNGF 606 proceeds with the remaining messages of the EAP re-authentication procedure. At 632, the IEEE security procedures are performed through the 4 ways handshake to establish a working key at the UE 601 and the target AP 603. At 634-636, when re-association together with link security establishment is done, the UE 601 starts sending UL traffic that can be handled by the target TNGF 606 based on IPSec security context received over N2. At 638, a N2 HO NOTIFY message is sent by the target TNGF 606 as defined in 3GPP TS 38.413. At 640, HO Execution phase is performed. This phrase includes interactions with the SMF 608 and the UPF 609. At 642, the AMF 607 sends a UE Context Release Command message to the source TNGF 605. Then, the source TNGF 605 release resources and then, at 644, transmits a UE Context Release Complete message to the AMF 607.

All operations and features as described above with reference to FIG. 4 are likewise applicable to the process 600 and have similar effects. For the purpose of simplification, the details will be omitted.

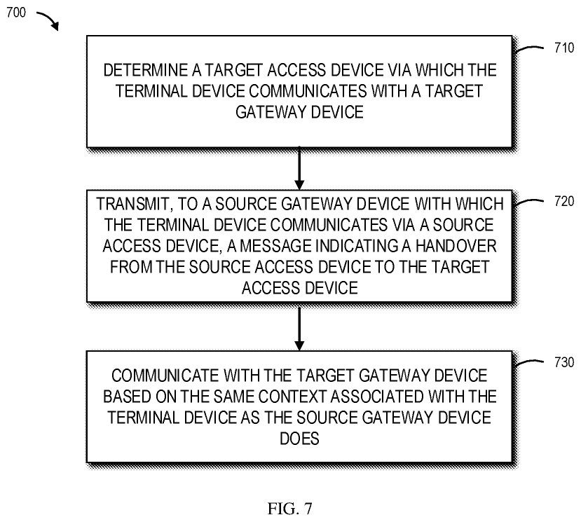

FIG. 7 shows a flowchart of an example method for a terminal device according to some example embodiments of the present disclosure. The method 700 can be implemented at the terminal device 201 as shown in FIG. 2. For the purpose of discussion, the method 700 will be described with reference to FIG. 2.

At block 710, the terminal device 201 determines a target access device 207 via which the terminal device 201 communicates with a target gateway device 209. At block 720, the terminal device 201 transmits, to the source gateway device 205 with which the terminal device 201 communicates via a source access device 203, a message indicating a handover from the source access device 203 to the target access device 207. At block 730, the terminal device 201 communicates with the target gateway device 209 based on the same context associated with the terminal device 201 as the source gateway device 205 does.

In some example embodiments, the context may comprise at least one of: security information for communication with the terminal device 201 at the target access device 207; and parameters associated with internet protocol security with the target gateway device 209.

In some example embodiments, the message may comprise at least one of: an identifier of the terminal device 201; and an identifier of the target access device 207.

In some example embodiments, the terminal device 201 may transmit, to the target access device 207, a request to associate with the target access device 207, the request comprising an identifier of the source access device 203; and receive, from the target access device 207, a response for the request.

Those skilled in the art can understand that all operations and features as described above with reference to FIGS. 3-6 are likewise applicable to the method 700 and have similar effects.

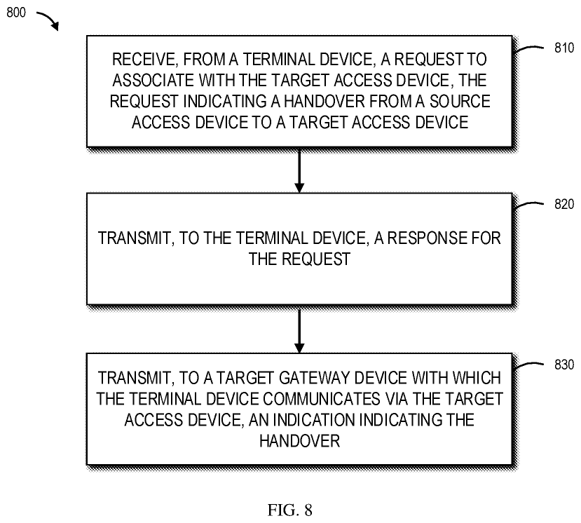

FIG. 8 shows a flowchart of an example method for a target access device 207 according to some example embodiments of the present disclosure. The method 800 can be implemented at the target access device 207 as shown in FIG. 2. For the purpose of discussion, the method 800 will be described with reference to FIG. 2.

At block 810, the target access device 207 receives, from a terminal device 201, a request to associate with the target access device 207, the request indicating a handover from a source access device 205 to a target access device 207. At block 820, the target access device 207 transmits, to the terminal device 201, a response for the request. At block 830, the target access device 207 transmits, to the target gateway device 209 with which the terminal device 201 communicates via the target access device 207, an indication indicating the handover.

In some example embodiments, the request may comprise an identifier of a source access device 203.

In some example embodiments, the indication may comprise at least one of: an identifier of the terminal device 201; the identifier of the source access device 203; and an identifier of the target access device 207.

Those skilled in the art can understand that all operations and features as described above with reference to FIGS. 3-6 are likewise applicable to the method 800 and have similar effects.

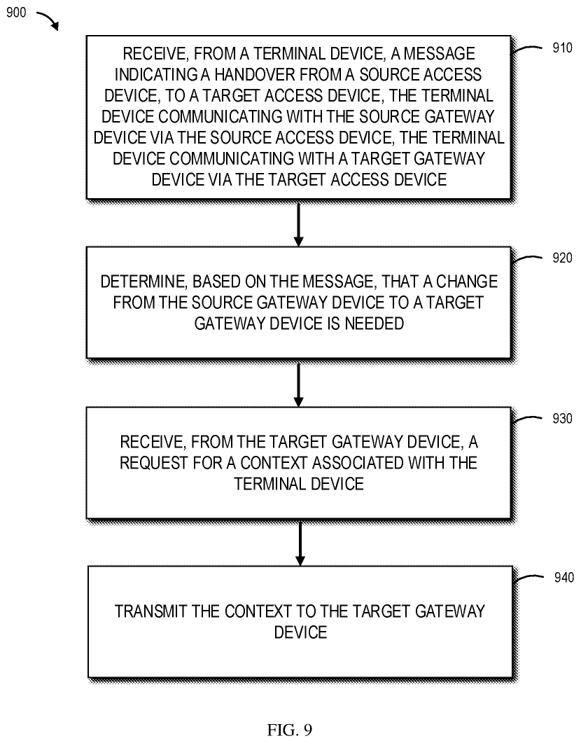

FIG. 9 shows a flowchart of an example method for a source gateway device according to some example embodiments of the present disclosure. The method 900 can be implemented at the source gateway device 205 as shown in FIG. 2. For the purpose of discussion, the method 900 will be described with reference to FIG. 2.

At block 910, the source gateway device 205 receives, from a terminal device 201, a message indicating a handover from the source access device 203 to a target access device 207, the terminal device 201 communicating with the source gateway device 205 via the source access device 203, the terminal device 201 communicating with a target gateway device 209 via the target access device 207. At block 920, the source gateway device 205 determines, based on the message, that a change from the source gateway device to a target gateway device is needed. At block 930, the source gateway device 205 receives, from the target gateway device 209, a request for a context associated with the terminal device 201. At block 940, the source gateway device 205 transmits the context to the target gateway device 209.

In some example embodiments, the message may comprise at least one of: an identifier of the terminal device 201; and an identifier of the target access device 207.

In some example embodiments, the request may comprise at least one of: the identifier of the terminal device 201; an identifier of the source access device; the identifier of the target access device 207; and an internet protocol address of the target gateway device 209.

In some example embodiments, the context may comprise at least one of: security information for communication with the terminal device 201 at the target access device 207; and parameters associated with internet protocol security with the target gateway device 209.

In some example embodiments, the source gateway device 205 may release resources for communication with the terminal device 201 by at least disabling an internet protocol security endpoint.

Those skilled in the art can understand that all operations and features as described above with reference to FIGS. 3 and 5 are likewise applicable to the method 900 and have similar effects.

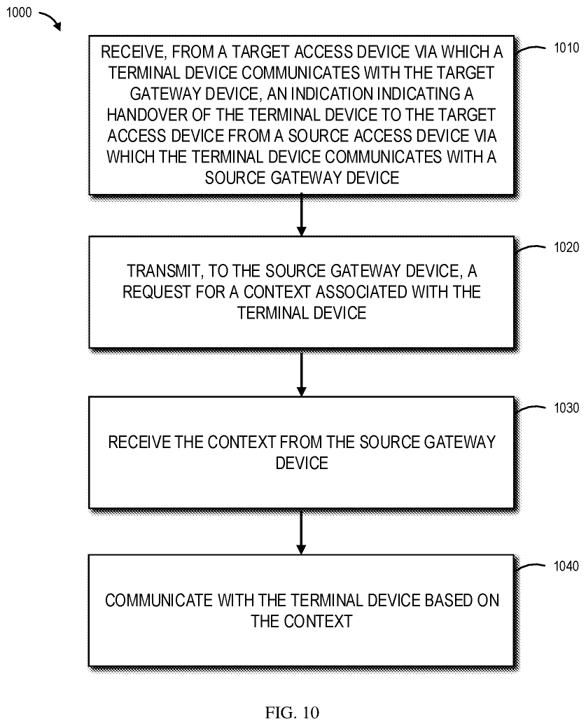

FIG. 10 shows a flowchart of an example method for a target gateway device 209 according to some example embodiments of the present disclosure. The method 1000 can be implemented at the target gateway device 209 as shown in FIG. 2. For the purpose of discussion, the method 1000 will be described with reference to FIG. 2.

At block 1010, the target gateway device 209 receives, from a target access device 207 via which a terminal device 201 communicates with the target gateway device 209, an indication indicating a handover of the terminal device 210 to the target access device 217 from a source access device 203 via which the terminal device communicates with a source gateway device 205. At block 1020, the target gateway device 209 transmits, to the source gateway device 205, a request for a context associated with the terminal device 201. At block 1030, the target gateway device 209 receives the context from the source gateway device 205. At block 1040, the target gateway device 209 communicates with the terminal device 201 based on the context.

In some example embodiments, the indication may comprise at least one of: an identifier of the terminal device 201; an identifier of the source access device; and an identifier of the target access device 207.

In some example embodiments, the target gateway device 209 may determine the source gateway device 205 based on the identifier of the source access device comprised in the indication.

In some example embodiments, the request may comprise at least one of: the identifier of the terminal device 201; the identifier of the source access device; the identifier of the target access device 207; and an internet protocol address of the target gateway device 209.

In some example embodiments, the context may comprise at least one of: security information for communication with the terminal device 201 at the target access device 207; and parameters associated with internet protocol security with the target gateway device 209.

Those skilled in the art can understand that all operations and features as described above with reference to FIGS. 3 and 5 are likewise applicable to the method 1000 and have similar effects.

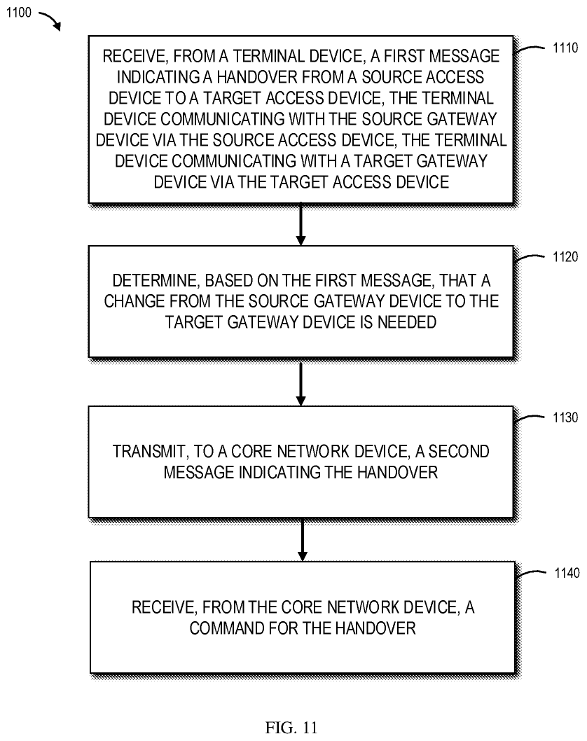

FIG. 11 shows a flowchart of an example method for a source gateway device according to some other example embodiments of the present disclosure. The method 1100 can be implemented at the source gateway device 205 as shown in FIG. 2. For the purpose of discussion, the method 1100 will be described with reference to FIG. 2.

At block 1110, the source gateway device 205 receives, from a terminal device 201, a first message indicating a handover from the source access device 203 to a target access device 207. At block 1120, the source gateway device 205 determines, based on the first message, that a change from the source gateway device to the target gateway device is needed. At block 1130, the source gateway device 205 transmits, to a core network device 211, a second message indicating the handover. At block 1140, the source gateway device 205 receives, from the core network device 211, a command for the handover.

In some example embodiments, the source gateway device 205 may, in response to the command, release resources for communication with the terminal device 201 by at least disabling an internet protocol security endpoint.

In some example embodiments, the first message may comprise at least one of: an identifier of the terminal device 201; and an identifier of the target access device 207.

In some example embodiments, the source gateway device 205 may determine the target gateway device 209 based on the identifier of the target access device 207.

In some example embodiments, the second message may comprise at least one of: the identifier of the target access device 207; an identifier of the target gateway device 209; a context associated with internet protocol security; and a context associated with authentication protocol security.

Those skilled in the art can understand that all operations and features as described above with reference to FIGS. 4 and 6 are likewise applicable to the method 1100 and have similar effects.

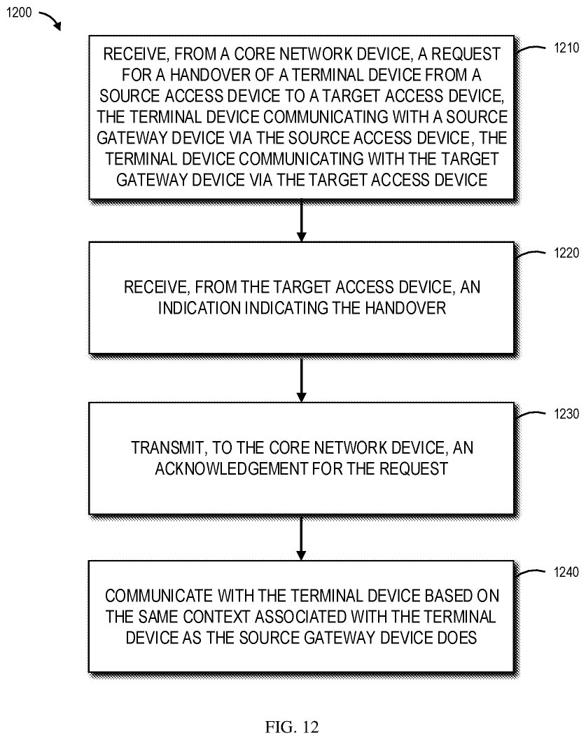

FIG. 12 shows a flowchart of an example method for a target gateway device 209 according to some other example embodiments of the present disclosure. The method 1200 can be implemented at the target gateway device 209 as shown in FIG. 2. For the purpose of discussion, the method 1200 will be described with reference to FIG. 2.

At block 1210, the target gateway device 209 receives, from a core network device 211, a request for a handover of a terminal device 201 from a source access device 203 to a target access device 207, the terminal device 201 communicating with a source gateway device 205 via the source access device 203, the terminal device 201 communicating with the target gateway device 209 via the target access device 207. At block 1220, the target gateway device 209 receives, from the target access device 207, an indication indicating the handover. At block 1230, the target gateway device 209 transmits, to the core network device 211, an acknowledgement for the request. At block 1240, the target gateway device 209 communicates with the terminal device 201 based on the same context associated with the terminal device 201 as the source gateway device 205 does.

In some example embodiments, the request may comprise at least one of: an identifier of the target gateway device 209; a context associated with internet protocol security; and a context associated with authentication protocol security.

In some example embodiments, the indication may comprise at least one of: an identifier of the terminal device 201; an identifier of the source access device; and an identifier of the target access device 207.

In some example embodiments, the context may comprise at least one of: security information for communication with the terminal device 201 at the target access device 207; and parameters associated with internet protocol security with the target gateway device 209.

Those skilled in the art can understand that all operations and features as described above with reference to FIGS. 4 and 6 are likewise applicable to the method 1200 and have similar effects.

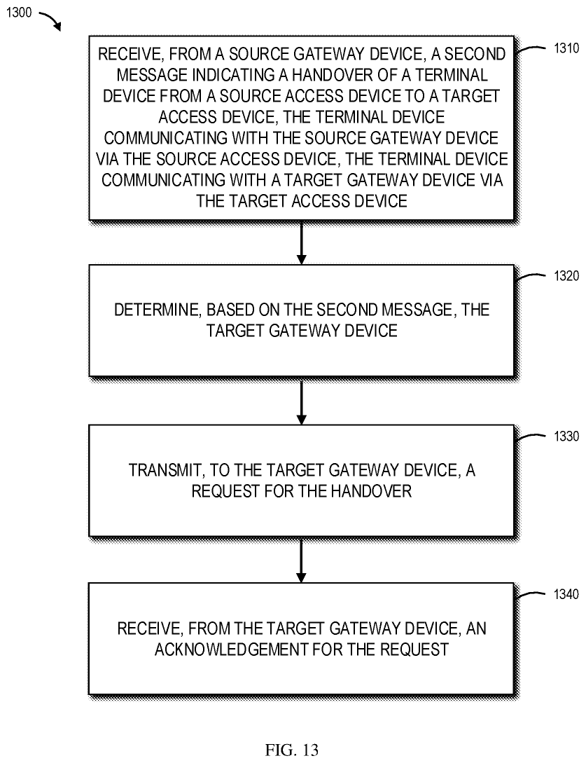

FIG. 13 shows a flowchart of an example method for a core network device 211 according to some example embodiments of the present disclosure. The method 1300 can be implemented at the core network device 211 as shown in FIG. 2. For the purpose of discussion, the method 1300 will be described with reference to FIG. 2.

At block 1310, the core network device 211 receives, from a source gateway device 205, a second message indicating a handover of a terminal device 201 from a source access device 203 to a target access device 207, the terminal device 201 communicating with the source gateway device 205 via the source access device 203, the terminal device 201 communicating with a target gateway device 209 via the target access device 207. At block 1320, the core network device 211 determines, based on the second message, the target gateway device 209. At block 1330, the core network device 211 transmits, to the target gateway device 209, a request for the handover. At block 1340, the core network device 211 receives, from the target gateway device 209, an acknowledgement for the request.

In some example embodiments, the second message may comprise at least one of: an identifier of the target access device 207; an identifier of the target gateway device 209; a context associated with internet protocol security; and a context associated with authentication protocol security.

In some example embodiments, the request may comprise at least one of: an identifier of the target gateway device 209; the context associated with internet protocol security; and the context associated with authentication protocol security.

In some example embodiments, the core network device 211 may perform a preparation for the handover based on the second message.

In some example embodiments, the core network device 211 may transmit, to the source gateway device 205, a command for the handover to release resources for communication with the terminal device 201 by at least disabling an internet protocol security endpoint.

Those skilled in the art can understand that all operations and features as described above with reference to FIGS. 4 and 6 are likewise applicable to the method 1300 and have similar effects.

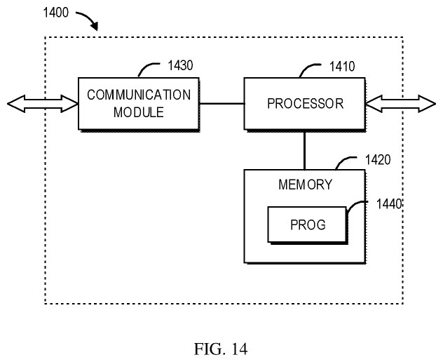

FIG. 14 is a simplified block diagram of a device 1400 that is suitable for implementing example embodiments of the present disclosure. The device 1400 can be implemented at or as a part of the terminal device 201, the source gateway device 205, the target access device 207, the target gateway device 209, and the core network device 211 as shown in FIG. 2.

As shown, the device 1400 includes a processor 1410, a memory 1420 coupled to the processor 1410, a communication module 1430 coupled to the processor 1410, and a communication interface (not shown) coupled to the communication module 1430. The memory 1420 stores at least a program 1440. The communication module 1430 is for bidirectional communication, for example, via multiple antennas. The communication interface may represent any interface that is necessary for communication.

The program 1440 is assumed to include program instructions that, when executed by the associated processor 1410, enable the device 1400 to operate in accordance with the example embodiments of the present disclosure, as discussed herein with reference to FIGS. 2-6. The example embodiments herein may be implemented by computer software executable by the processor 1410 of the device 1400, or by hardware, or by a combination of software and hardware. The processor 1410 may be configured to implement various example embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

When the device 1400 acts as the terminal device 201 or a part of the terminal device 201, the processor 1410 and the communication module 1430 may cooperate to implement the method 700 as described above with reference to FIG. 7. When the device 1400 acts as the target access device 207 or a part of the target access device 207, the processor 1410 and the communication module 1430 may cooperate to implement the method 800 as described above with reference to FIG. 8. When the device 1400 acts as the source gateway device 205 or a part of the source gateway device 205, the processor 1410 and the communication module 1430 may cooperate to implement the method 900 or 1100 as described above with reference to FIGS. 9 and 11. When the device 1400 acts as the target gateway device 209 or a part of the target gateway device 209, the processor 1410 and the communication module 1430 may cooperate to implement the method 1000 or 1200 as described above with reference to FIGS. 10 and 12. When the device 1400 acts as the core network device 211 or a part of the core network device 211, the processor 1410 and the communication module 1430 may cooperate to implement the method 1300 as described above with reference to FIG. 13. All operations and features as described above with reference to FIGS. 2-13 are likewise applicable to the device 1400 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out any of the methods 700-1300 as described above with reference to FIGS. 7-13. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a terminal device, determining a target access device via which the terminal device communicates with a target gateway device; transmitting, to a source gateway device with which the terminal device communicates via a source access device, a message indicating a handover from the source access device to the target access device; and communicating with the target gateway device based on the same context associated with the terminal device as the source gateway device does.

In some example embodiments, the context comprises at least one of: security information for communication with the terminal device at the target access device; and parameters associated with internet protocol security with the target gateway device.

In some example embodiments, the message comprises at least one of: an identifier of the terminal device; and an identifier of the target access device.

In some example embodiments, the method further comprises: transmitting, to the target access device, a request to associate with the target access device, the request comprising an identifier of the source access device; and receiving, from the target access device, a response for the request.

In some aspects, a method comprises: at a target access device, receiving, from a terminal device, a request to associate with the target access device, the request indicating a handover from a source access device to the target access device; transmitting, to the terminal device, a response for the request; and transmitting, to a target gateway device with which the terminal device communicates via the target access device, an indication indicating the handover.

In some example embodiments, the request comprises an identifier of the source access device.

In some example embodiments, the indication comprises at least one of: an identifier of the terminal device; the identifier of the source access device; and an identifier of the target access device.

In some aspects, a method comprises: at a source gateway device, receiving, from a terminal device, a message indicating a handover from a source access device to a target access device, the terminal device communicating with the source gateway device via the source access device, the terminal device communicating with a target gateway device via the target access device; determining, based on the message, that a change from the source gateway device to a target gateway device is needed; receiving, from the target gateway device, a request for a context associated with the terminal device; and transmitting the context to the target gateway device.

In some example embodiments, the message comprises at least one of: an identifier of the terminal device; and an identifier of the target access device.

In some example embodiments, the request comprises at least one of: the identifier of the terminal device; an identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some example embodiments, the method further comprises: releasing resources for communication with the terminal device by at least disabling an internet protocol security endpoint.

In some aspects, a method comprises: at a target gateway device, receiving, from a target access device via which a terminal device communicates with the target gateway device, an indication indicating a handover of the terminal device to the target access device from a source access device via which the terminal device communicates with a source gateway device; transmitting, to the source gateway device, a request for a context associated with the terminal device; receiving the context from the source gateway device; and communicating with the terminal device based on the context.

In some example embodiments, the indication comprises at least one of: an identifier of the terminal device; an identifier of the source access device.

In some example embodiments, the method further comprises: determining the source gateway device based on the identifier of the source access device comprised in the indication.

In some example embodiments, the request comprises at least one of: the identifier of the terminal device; the identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some aspects, a method comprises: at a source gateway device, receiving, from a terminal device, a first message indicating a handover from a source access device to a target access device, the terminal device communicating with the source gateway device via the source access device, the terminal device communicating with a target gateway device via the target access device; determining, based on the first message, that a change from the source gateway device to the target gateway device is needed; transmitting, to a core network device, a second message indicating the handover; and receiving, from the core network device, a command for the handover.

In some example embodiments, the method further comprises: in response to the command, releasing resources for communication with the terminal device by at least disabling an internet protocol security endpoint.

In some example embodiments, the first message comprises at least one of: an identifier of the terminal device; and an identifier of the target access device.

In some example embodiments, the method further comprises: determining the target gateway device based on the identifier of the target access device.

In some example embodiments, the second message comprises at least one of: the identifier of the target access device; an identifier of the target gateway device; a context associated with internet protocol security; and a context associated with authentication protocol security.

In some aspects, a method comprises: at a target gateway device, receiving, from a core network device, a request for a handover of a terminal device from a source access device to a target access device, the terminal device communicating with a source gateway device via the source access device, the terminal device communicating with the target gateway device via the target access device; receiving, from the target access device, an indication indicating the handover; transmitting, to the core network device, an acknowledgement for the request; and communicating with the terminal device based on the same context associated with the terminal device as the source gateway device does.

In some example embodiments, the request comprises at least one of: an identifier of the target gateway device; a context associated with internet protocol security; and a context associated with authentication protocol security.

In some example embodiments, the indication comprises at least one of: an identifier of the terminal device; an identifier of the source access device; and an identifier of the target access device.

In some example embodiments, the context comprises at least one of: security information for communication with the terminal device at the target access device; and parameters associated with internet protocol security with the target gateway device.

In some aspects, a method comprises: at a core network device, receiving, from a source gateway device, a second message indicating a handover of a terminal device from a source access device to a target access device, the terminal device communicating with the source gateway device via the source access device, the terminal device communicating with a target gateway device via the target access device; determining, based on the second message, the target gateway device; transmitting, to the target gateway device, a request for the handover; and receiving, from the target gateway device, an acknowledgement for the request.

In some example embodiments, the second message comprises at least one of: an identifier of the target access device; an identifier of the target gateway device; a context associated with internet protocol security; and a context associated with authentication protocol security.

In some example embodiments, the request comprises at least one of: an identifier of the target gateway device; the context associated with internet protocol security; and the context associated with authentication protocol security.

In some example embodiments, the method further comprising: performing a preparation for the handover based on the second message.

In some example embodiments, the method further comprises: transmitting, to the source gateway device, a command for the handover to release resources for communication with the terminal device by at least disabling an internet protocol security endpoint.

In some aspects, a terminal device comprises: at least one processor; and at least one memory including computer program code; the at least one memory and the computer program code configured to, with the at least one processor, cause the terminal device to: determine a target access device via which the terminal device communicates with a target gateway device; transmit, to a source gateway device with which the terminal device communicates via a source access device, a message indicating a handover from the source access device to the target access device; and communicate with the target gateway device based on the same context associated with the terminal device as the source gateway device does.

In some example embodiments, the context comprises at least one of: security information for communication with the terminal device at the target access device; and parameters associated with internet protocol security with the target gateway device.

In some example embodiments, the message comprises at least one of: an identifier of the terminal device; and an identifier of the target access device.

In some example embodiments, the terminal device is further caused to: transmit, to the target access device, a request to associate with the target access device, the request comprising an identifier of the source access device; and receive, from the target access device, a response for the request.

In some aspects, a target access device, comprises: at least one processor; and at least one memory including computer program code; the at least one memory and the computer program code configured to, with the at least one processor, cause the target access device to: receive, from a terminal device, a request to associate with the target access device, the request indicating a handover from a source access device to the target access device; transmit, to the terminal device, a response for the request; and transmit, to a target gateway device with which the terminal device communicates via the target access device, an indication indicating the handover.

In some example embodiments, the request comprises an identifier of the source access device.

In some example embodiments, the indication comprises at least one of: an identifier of the terminal device; the identifier of the source access device; and an identifier of the target access device.

In some aspects, a source gateway device, comprises: at least one processor; and at least one memory including computer program code; the at least one memory and the computer program code configured to, with the at least one processor, cause the source gateway device to: receive, from a terminal device, a message indicating a handover from a source access device, to a target access device, the terminal device communicating with the source gateway device via the source access device, the terminal device communicating with a target gateway device via the target access device; determine, based on the message, that a change from the source gateway device to a target gateway device is needed; receive, from the target gateway device, a request for a context associated with the terminal device; and transmit the context to the target gateway device.

In some example embodiments, the message comprises at least one of: an identifier of the terminal device; and an identifier of the target access device.

In some example embodiments, the request comprises at least one of: the identifier of the terminal device; an identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some example embodiments, the source gateway device is further caused to: release resources for communication with the terminal device by at least disabling an internet protocol security endpoint.

In some aspects, a target gateway device, comprises: at least one processor; and at least one memory including computer program code; the at least one memory and the computer program code configured to, with the at least one processor, cause the target gateway device to: receive, from a target access device via which a terminal device communicates with the target gateway device, an indication indicating a handover of the terminal device to the target access device from a source access device via which the terminal device communicates with a source gateway device; transmit, to the source gateway device, a request for a context associated with the terminal device; receive the context from the source gateway device; and communicate with the terminal device based on the context.

In some example embodiments, the indication comprises at least one of: an identifier of the terminal device; an identifier of the source access device; and an identifier of the target access device.

In some example embodiments, the target gateway device is further caused to: determine the source gateway device based on the identifier of the source access device comprised in the indication.

In some example embodiments, the request comprises at least one of: the identifier of the terminal device; the identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some aspects, a source gateway device, comprises: at least one processor; and at least one memory including computer program code; the at least one memory and the computer program code configured to, with the at least one processor, cause the source gateway device to: receive, from a terminal device, a first message indicating a handover from a source access device to a target access device, the terminal device communicating with the source gateway device via the source access device, the terminal device communicating with a target gateway device via the target access device; determine, based on the first message, that a change from the source gateway device to the target gateway device is needed; transmit, to a core network device, a second message indicating the handover; and receive, from the core network device, a command for the handover.

In some example embodiments, the source gateway device is further caused to: in response to the command, release resources for communication with the terminal device by at least disabling an internet protocol security endpoint.

In some example embodiments, the first message comprises at least one of: an identifier of the terminal device; and an identifier of the target access device.

In some example embodiments, the source gateway device is further caused to: determine the target gateway device based on the identifier of the target access device.

In some example embodiments, the second message comprises at least one of: the identifier of the target access device; an identifier of the target gateway device; a context associated with internet protocol security; and a context associated with authentication protocol security.

In some aspects, a target gateway device, comprises: at least one processor; and at least one memory including computer program code; the at least one memory and the computer program code configured to, with the at least one processor, cause the target gateway device to: receive, from a core network device, a request for a handover of a terminal device from a source access device to a target access device, the terminal device communicating with a source gateway device via the source access device, the terminal device communicating with the target gateway device via the target access device; receive, from the target access device, an indication indicating the handover; transmit, to the core network device, an acknowledgement for the request; and communicate with the terminal device based on the same context associated with the terminal device as the source gateway device does.

In some example embodiments, the request comprises at least one of: an identifier of the target gateway device; a context associated with internet protocol security; and a context associated with authentication protocol security.

In some example embodiments, the indication comprises at least one of: an identifier of the terminal device; an identifier of the source access device; and an identifier of the target access device.

In some example embodiments, the context comprises at least one of: security information for communication with the terminal device at the target access device; and parameters associated with internet protocol security with the target gateway device.

In some aspects, a core network device, comprises: at least one processor; and at least one memory including computer program code; the at least one memory and the computer program code configured to, with the at least one processor, cause the core network device to: receive, from a source gateway device, a second message indicating a handover of a terminal device from a source access device to a target access device, the terminal device communicating with the source gateway device via the source access device, the terminal device communicating with a target gateway device via the target access device; determine, based on the second message, the target gateway device; transmit, to the target gateway device, a request for the handover; and receive, from the target gateway device, an acknowledgement for the request.

In some example embodiments, the second message comprises at least one of: an identifier of the target access device; an identifier of the target gateway device; a context associated with internet protocol security; and a context associated with authentication protocol security.

In some example embodiments, the request comprises at least one of: an identifier of the target gateway device; the context associated with internet protocol security; and the context associated with authentication protocol security.

In some example embodiments, the core network device is further caused to: perform a preparation for the handover based on the second message.

In some example embodiments, the core network device is further caused to: transmit, to the source gateway device, a command for the handover to release resources for communication with the terminal device by at least disabling an internet protocol security endpoint.

In some aspects, an apparatus comprises: means for determining a target access device via which the terminal device communicates with a target gateway device; means for transmitting, to a source gateway device with which the terminal device communicates via a source access device, a message indicating a handover from the source access device to the target access device; and means for communicating with the target gateway device based on the same context associated with the terminal device as the source gateway device does.

In some example embodiments, the context comprises at least one of: security information for communication with the terminal device at the target access device; and parameters associated with internet protocol security with the target gateway device.

In some example embodiments, the message comprises at least one of: an identifier of the terminal device; and an identifier of the target access device.

In some example embodiments, the apparatus further comprises: means for transmitting, to the target access device, a request to associate with the target access device, the request comprising an identifier of the source access device; and means for receiving, from the target access device, a response for the request.

In some aspects, an apparatus comprises: means for receiving, from a terminal device, a request to associate with the target access device, the request indicating a handover from a source access device to the target access device; means for transmitting, to the terminal device, a response for the request; and means for transmitting, to a target gateway device with which the terminal device communicates via the target access device, an indication indicating the handover.

In some example embodiments, the request comprises an identifier of the source access device.

In some example embodiments, the indication comprises at least one of: an identifier of the terminal device; the identifier of the source access device; and an identifier of the target access device.

In some aspects, an apparatus comprises: means for receiving, from a terminal device, a message indicating a handover from a source access device to a target access device, the terminal device communicating with the source gateway device via the source access device, the terminal device communicating with a target gateway device via the target access device; means for determining, based on the message, that a change from the source gateway device to a target gateway device is needed; means for receiving, from the target gateway device, a request for a context associated with the terminal device; and means for transmitting the context to the target gateway device.

In some example embodiments, the message comprises at least one of: an identifier of the terminal device; and an identifier of the target access device.

In some example embodiments, the request comprises at least one of: the identifier of the terminal device; an identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some example embodiments, the apparatus further comprises: means for releasing resources for communication with the terminal device by at least disabling an internet protocol security endpoint.

In some aspects, an apparatus comprises: means for receiving, from a target access device via which a terminal device communicates with the target gateway device, an indication indicating a handover of the terminal device to the target access device from a source access device via which the terminal device communicates with a source gateway device; means for transmitting, to the source gateway device, a request for a context associated with the terminal device; means for receiving the context from the source gateway device; and means for communicating with the terminal device based on the context.

In some example embodiments, the indication comprises at least one of: an identifier of the terminal device; an identifier of the source access device.

In some example embodiments, the apparatus further comprises: means for determining the source gateway device based on the identifier of the source access device comprised in the indication.

In some example embodiments, the request comprises at least one of: the identifier of the terminal device; the identifier of the source access device; the identifier of the target access device; and an internet protocol address of the target gateway device.

In some example embodiments, the context comprises at least one of: security information for communication with the terminal device at the target access device; and parameters associated with internet protocol security with the target gateway device.

In some aspects, an apparatus comprises: means for receiving, from a terminal device, a first message indicating a handover from a source access device to a target access device, the terminal device communicating with the source gateway device via the source access device, the terminal device communicating with a target gateway device via the target access device; means for determining, based on the first message, that a change from the source gateway device to the target gateway device is needed; means for transmitting, to a core network device, a second message indicating the handover; and means for receiving, from the core network device, a command for the handover.

In some example embodiments, the apparatus further comprises: means for in response to the command, releasing resources for communication with the terminal device by at least disabling an internet protocol security endpoint.

In some example embodiments, the first message comprises at least one of: an identifier of the terminal device; and an identifier of the target access device.

In some example embodiments, the apparatus further comprises: means for determining the target gateway device based on the identifier of the target access device.

In some example embodiments, the second message comprises at least one of: the identifier of the target access device; an identifier of the target gateway device; a context associated with internet protocol security; and a context associated with authentication protocol security.

In some aspects, an apparatus comprises: means for receiving, from a core network device, a request for a handover of a terminal device from a source access device to a target access device, the terminal device communicating with a source gateway device via the source access device, the terminal device communicating with the target gateway device via the target access device; means for receiving, from the target access device, an indication indicating the handover; means for transmitting, to the core network device, an acknowledgement for the request; and means for communicating with the terminal device based on the same context associated with the terminal device as the source gateway device does.

In some example embodiments, the request comprises at least one of: an identifier of the target gateway device; a context associated with internet protocol security; and a context associated with authentication protocol security.

In some example embodiments, the indication comprises at least one of: an identifier of the terminal device; an identifier of the source access device; and an identifier of the target access device.

In some example embodiments, the context comprises at least one of: security information for communication with the terminal device at the target access device; and parameters associated with internet protocol security with the target gateway device.

In some aspects, an apparatus comprises: means for receiving, from a source gateway device, a second message indicating a handover of a terminal device from a source access device to a target access device, the terminal device communicating with the source gateway device via the source access device, the terminal device communicating with a target gateway device via the target access device; means for determining, based on the second message, the target gateway device; means for transmitting, to the target gateway device, a request for the handover; and means for receiving, from the target gateway device, an acknowledgement for the request.

In some example embodiments, the second message comprises at least one of: an identifier of the target access device; an identifier of the target gateway device; a context associated with internet protocol security; and a context associated with authentication protocol security.

In some example embodiments, the request comprises at least one of: an identifier of the target gateway device; the context associated with internet protocol security; and the context associated with authentication protocol security.

In some example embodiments, the method further comprising: performing a preparation for the handover based on the second message.

In some example embodiments, the apparatus further comprises: means for transmitting, to the source gateway device, a command for the handover to release resources for communication with the terminal device by at least disabling an internet protocol security endpoint.

In some aspects, a computer readable storage medium comprises program instructions stored thereon, the instructions, when executed by a processor of a device, causing the device to perform the method according to some example embodiments of the present disclosure.

1. A terminal device, comprising:
at least one processor; and
at least one memory including computer program code;
the computer program code configured to, when executed by the at least one processor, cause the terminal device to:
determine a target non-3GPP access device via which the terminal device is to communicate with a target gateway device;
transmit, to a source gateway device with which the terminal device communicates via a source non-3GPP access device, a message indicating a handover from the source non-3GPP access device to the target non-3GPP access device; and
communicate with the target gateway device using a context associated with the terminal device, wherein the context associated with the terminal device is a context used for communications between the terminal device any gateway device, including the source gateway device and the target gateway device.

2. The terminal device of claim 1, wherein the context comprises at least one of:
security information to be used for communications between the terminal device and the target non-3GPP access device; and
parameters associated with internet protocol security, wherein the parameters are to be used for communications between the terminal device and the target gateway device.

3. The terminal device of claim 1, wherein the message comprises at least one of:
an identifier of the terminal device; and
an identifier of the target non-3GPP access device.

4. The terminal device of claim 1, wherein the is further configured to, when executed by the at least one processor, to cause the terminal device to:
transmit, to the target non-3GPP access device, a request to associate the terminal device with the target non-3GPP access device, the request comprising an identifier of the source non-3GPP access device; and
receive, from the target non-3GPP access device, a response to the request.

5.-7. (canceled)

8. A source gateway device, comprising:
at least one processor; and
at least one memory including computer program code,
the computer program code configured to, when executed by the at least one processor, cause the source gateway device to:
receive, from a terminal device, a message indicating a handover from a source non-3GPP access device, to a target non-3GPP access device, the source gateway device communicating with the terminal device via the source non-3GPP access device;
determine, based on the message, that a change from the source gateway device to a target gateway device is needed;
receive, from the target gateway device, a request for a context associated with the terminal device, wherein the context associated with the terminal device is a context used for communications between the terminal device any gateway device, including the source gateway device and the target gateway device; and
transmit, based on receipt of the request, the context to the target gateway device.

9. The source gateway device of claim 8, wherein the message comprises at least one of:
an identifier of the terminal device; and
an identifier of the target non-3GPP access device.

10. The source gateway device of claim 8, wherein the request comprises at least one of:
the identifier of the terminal device;
an identifier of the source non-3GPP access device;
the identifier of the target non-3GPP access device; and
an internet protocol address of the target gateway device.

11. The source gateway device of claim 8, wherein the context comprises at least one of:
security information to be used for communications between the terminal device and the target non-3GPP access device; and
parameters associated with internet protocol security, wherein the parameters are to be used for communications between the terminal device and the target gateway device.

12. The source gateway device of claim 8, wherein the computer code is further configured to, when executed by the at least one processor, cause the source gateway device to:
release resources used for communications with the terminal device by at least disabling an internet protocol security endpoint.

13. A target gateway device, comprising:
at least one processor; and
at least one memory including computer program code;
the computer program code configured to, when executed by the at least one processor, cause the target gateway device to:
receive, from a non-3GPP target access device via which the target gateway device is to communicate with a terminal device, an indication indicating a handover of the terminal device to the non-3GPP target access device from a source non-3GPP access device via which the terminal device communicates with a source gateway device;
transmit, to the source gateway device, a request for a context associated with the terminal device, wherein the context associated with the terminal device is a context used for communications between the terminal device any gateway device, including the source gateway device and the target gateway device;
receive the context from the source gateway device; and
communicate with the terminal device using the context.

14. The target gateway device of claim 13, wherein the indication comprises at least one of:
an identifier of the terminal device;
an identifier of the source non-3GPP access device; and
an identifier of the target non-3GPP access device.

15. The target gateway device of claim 14, wherein the computer code is further configured to, when executed by the at least one processor to cause the target gateway device to:
determine the source gateway device based on the identifier of the source non-3GPP access device comprised in the indication.

16. The target gateway device of claim 14, wherein the request comprises at least one of:
the identifier of the terminal device;
the identifier of the source non-3GPP access device;
the identifier of the target non-3GPP access device; and
an internet protocol address of the target gateway device.

17. The target gateway device of claim 13, wherein the context comprises at least one of:
security information to be used for communications between the terminal device and the target non-3GPP access device; and
parameters associated with internet protocol security, wherein the parameters are to be used for communications between the terminal device and the target gateway device.

18.-46. (canceled)
